(19) United States
(12) Patent Application Publication
(10) Pub. No.: US 2009/0222395 A1
(43) Pub. Date: Sep. 3, 2009

(54) SYSTEMS, METHODS, AND SOFTWARE FOR ENTITY EXTRACTION AND RESOLUTION COUPLED WITH EVENT AND RELATIONSHIP EXTRACTION

(76) Inventors: Marc Light, St. Paul, MN (US); Frank Schilder, St. Paul, MN (US); Ravi Kumar Kondadadi, Eagan, MN (US); Christopher C. Dozier, Minneapolis, MN (US); Wenhui Liao, Minneapolis, MN (US); Sriharsha Veeramachaneni, St. Paul, MN (US)

Correspondence Address: SCHWEGMAN, LUNDBERG & WOESSNER, P.A., P.O. BOX 2938, MINNEAPOLIS, MN, 55402, US

(21) Appl. No.: 12/341,926

(22) Filed: Dec. 22, 2008

Related U.S. Application Data
(60) Provisional application No. 61/008,714, filed on Dec. 21, 2007.
(60) Provisional application No. 61/063,047, filed on Jan. 30, 2008.

(51) Int. Cl. G06N 5/02

(52) U.S. Cl. 706/47; 706/50; 706/54

(57) ABSTRACT

For automated text processing, the inventors devised, among other things, an exemplary system that includes an entity tagger, an entity resolver, a text segment classifier, and a relationship extractor. The entity tagger receives an input text segment, and tags named entities with the segment as being a person, company, or place. The entity resolver accesses authority files, and associates the persons and companies named in the text segment with specific entries in the files. The text segment classifier determines whether the text segment includes a relationship event, such as job-change event or merger and acquisition event, and if an event is detected, the relationship extractor determines the event role of entities named in the segment. For example, the extractor determines for a merger and acquisition event, which named company was the acquirer and which was acquired.

### RELATED APPLICATIONS

This application claims priority to U.S. Provisional Application 61/008,714 which was filed Dec. 21, 2007 and to U.S. Provisional Application 61/063,047 which was filed Jan. 30, 2008. Both of these provisional applications are incorporated herein by reference.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2007-2008, Thomson Reuters Global Resources.

### TECHNICAL FIELD

Various embodiments of the present invention concern extraction of data and related information from documents, such as identifying and tagging names and events in text and automatically inferring relationships between tagged entities, events, and so forth.

### BACKGROUND

The present inventors recognized a need to provide information consumers relational and event information about entities, such as companies, persons, cities, that are mentioned in electronic documents. For example, documents, such as news feeds, SEC (Securities and Exchange Commission) filings or scientific articles, may indicate that Company A merged with Company B, that Lawyer C moved to Firm D, or that the interaction of protein E with protein F produces result G.

However, automatically discerning the relational and event information about these entities is difficult and time consuming even with state-of-the art computing equipment, because an event description can be found in a single sentence or spread out over a paragraph, a document or an entire collection of documents.

### SUMMARY

To address this and/or other needs, the present inventors devised, among other things, systems and methods for named-entity tagging, resolving and event and relationship extraction.

An exemplary system includes an entity tagger, an entity resolver, a text segment classifier, and a relationship extractor. The entity tagger receives an input text segment, and tags named entities with the segment as being a person, company, or place. In response, the entity resolver accesses an authority files, and associates the persons and companies named in the text segment with specific entries in the authority files. The text segment classifier determines whether the entity tagged and resolved text segment includes a relationship event, such as job-change event or merger and acquisition. For a text segment that includes the relationship event, the relationship extractor determines the role of named entities in the text segment within the event. For example, the extractor determines for a merger and acquisition event, which named company was the acquirer and which was acquired.

### BRIEF DESCRIPTION OF THE DRAWINGS

FIG. 1 is a block and flow diagram of an exemplary system for named-entity tagging, resolving and event extraction, which corresponds to one or more embodiments of the present invention.

FIG. 2 is a diagram illustrating guided sequence decoding for named-entity tagging which corresponds to one or more embodiments of the present invention.

FIG. 3 is a block diagram of an exemplary named-entity tagging, resolution, and event extraction system corresponding to one or more embodiments of the present invention.

FIG. 4 is a flow chart of an exemplary method of named-entity tagging and resolution and event extraction corresponding to one or more embodiments of the present invention

### DETAILED DESCRIPTION OF THE EXEMPLARY EMBODIMENT(S)

This description, which incorporates the Figures and the claims, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

### Exemplary Named-Entity Tagging and Resolution System

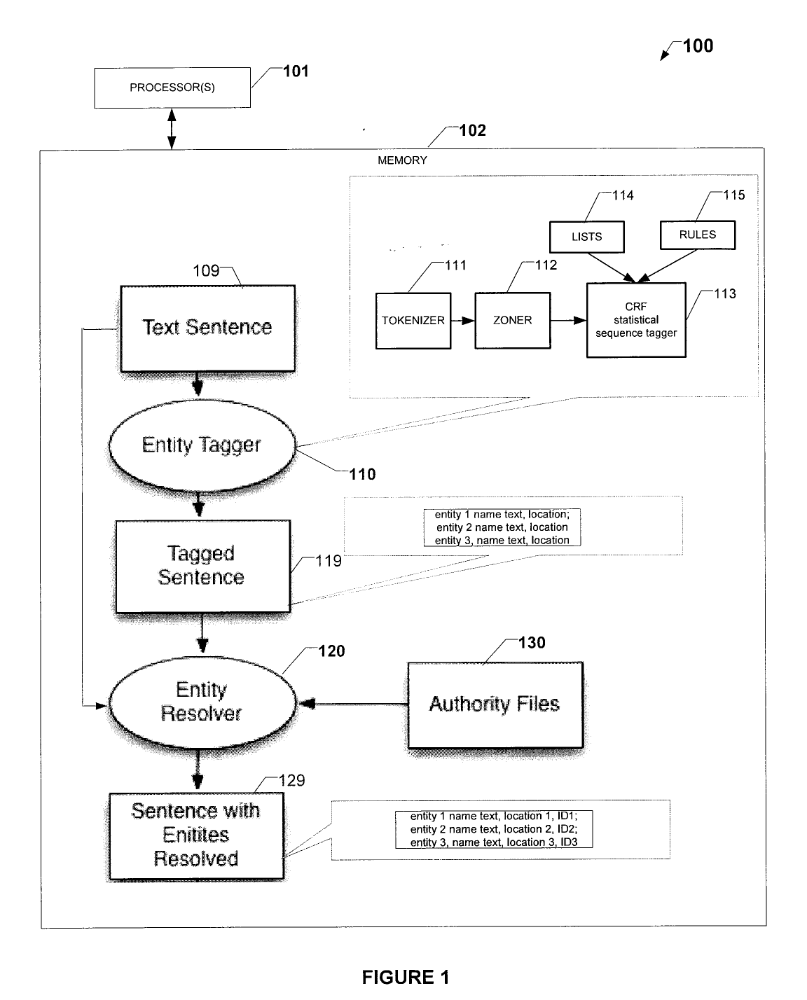

FIG. 1 shows an exemplary named entity tagging and resolving system 100. In addition to processors 101 and a memory 102, system 100 includes an entity tagger 110, an entity resolver 120, and authority files 130. (Tagger 110, resolver 120, and authority files 130 are implemented using machine-readable data and/or machine-executable instructions stored on memory 102, which may take a variety of consolidated and/or distributed forms.

Entity tagger 110, which receives textual input in the form of documents or other text segments, such as a sentence 109, includes a tokenizer 111, a zoner 112, and a statistical tagger 113.

Tokenizer 111 processes and classifies sections of a string of input characters, such as sentence 109. The process of tokenization is used to split the sentence or other text segment into word tokens. The resulting tokens are output to zoner 112.

Zoner 112 locates parts of the text that need to be processed for tagging, using patterns or rules. For example, the zoner may isolate portions of the document or text having proper names. After that determination, the parts of the text that need to be processed further are passed to statistical sequence tagger 113.

Statistical sequence tagger 113 (or decoder) uses one or more unambiguous name lists (lookup tables) 114 and rules 115 to tag the text within sentence 109 as company, person, or place or as a non-name. The rules and lists are regarded herein as high-precision classifiers.

Exemplary pattern rules can be implemented using regex+Java, Jape rules within GATE, ANTLR, and so forth. A sample rule for illustration dictates that “if a sequence of words is capitalized and ends with “Inc.” then it is tagged as a company or organization. The rules are developed by a human (for example, a researcher) and encoded in a rule formalism or directly in a procedural programming language. These rules tag an entity in the text when the preconditions of the rule are satisfied.

Exemplary name lists identify companies, such as Microsoft, Google, AT&T, Medtronics, Xerox; places, such as Minneapolis, Fort Dodge, Des Moines, Hong Kong; and drugs, such as Vioxx, Viagra, Aspirin, Penicillin. In the exemplary embodiment, the lists are produced offline and made available during runtime. To produce the list, a large corpus of documents, for example, a set of news stories, is passed through a statistical model and/or various rules (for example, a CRF model) to determine if the name is considered unambiguous. Exemplary rules for creating the lists include: 1) being listed in a common noun dictionary; and 2) being used as company name more than ninety percent of the time the name is mentioned in a corpus. The lookup tagger also finds systematic variants of the names to add to the unambiguous list. In addition, the lookup tagger guides and forces partial solutions. Using this list assists the statistical model (the sequence tagger) by immediately pinning that exact name without having to make any statistical determinations.

Examples of statistical sequence classifiers include linear chain conditional random field (CRF) classifiers, which provide both accuracy and speed. Integrating such high precision classifiers with the statistical sequence labeling approach entails first modifying the feature set of the original statistical model by including features corresponding to the labels assigned by the high-precision classifiers, in effect turning “on” the appropriate label features depending on the label assigned by the external classifier. Second, at run time, a Viterbi decoder (or a decoder similar in function) is constrained to respect the partially labeled or tagged sequences assigned by the high-precision classifiers.

This form of guided decoding provides several benefits. First, the speed of the decoding is enhanced, because the search space is constrained by the pretagging. Second, results are more consistence, because three sources of knowledge are taken account: the lists, the rules, and trained decoder statistical model. The third benefit is an ease of customization that stems from an elimination of a need to retrain the decoder if new rules and list items are added.

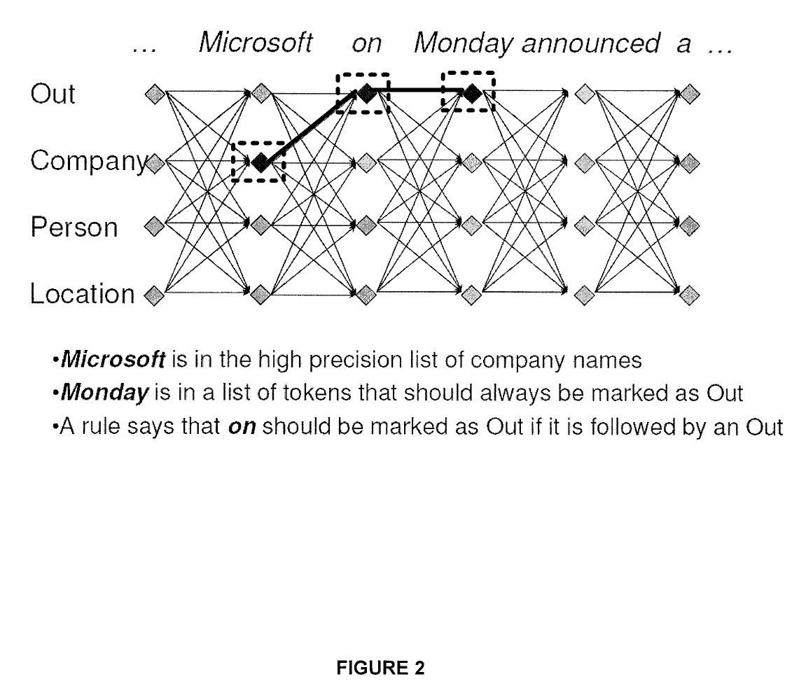

FIG. 2 is a conceptual diagram showing how a text segment “Microsoft on Monday announced a” is pretagged and how this pretagging (or pinning) constrains the possible tags or labeling options that a decoder, such as Viterbi decoder, has to process. In the Figure, the term Microsoft is tagged or pinned as a company based on its inclusion in a list of company names; the term Monday is marked as “out” based on its inclusion of a list of terms that should always be marked as “out”; and the term “on” is marked as out based on a rule that it should be marked as “out”, if it is followed by an term that is marked as “out” in this case the term “Monday.”

In the exemplary embodiment, the statistical sequence tagger calculates the probability of a sequence of tags given the input text. The parameters of the model are estimated from a corpus of training data, that is, text where a human has annotated all entity mentions or occurrences. (Unannotated text may also be used to improve the estimation of the parameters.) The statistical model then assembles training data, develops a feature set and utilizes rules for pinning. Pinning is a specific way to use a statistical model to tag a sequence of characters and to integrate many different types of information and methods into the tagging process.

The statistical model locates the character offset positions (that is, beginning and end) in the document for each named entity. The document is a sequence of characters; therefore, the character offset positions are determined. For example, within the sentence “Hank's Hardware, Inc. has a sale going on right now,” the piece of text “Hank's Hardware, Inc.” has an offset position of (0, 20). The sequence of characters has a beginning point and an ending point; however the path in between those points varies.

After the character offset positions are located, information about the entity is identified through the use of features. This information ranges from general information (that is, determining text is last name) to specific information (e.g., unique identifier). The exemplary embodiment uses the features discussed below, but other embodiments use other types and numbers amounts of features:
Regular expressions: contains an uppercase letter, last char is a dot, Acronym format, contains a digit, punctuation
Single word lists: last names, job titles, loc words, etc.
Multi-word lists: country names, country capitals, universities, company names, state names, etc.
Combination features: title@-1 AND (firstname OR last)
Copy features: copies features from one token to neighboring tokens, for example, the token two to the left of me is capitalized (Cap@-2)
The word itself features: “was” has the feature was@0
First-sentence features: copy features from 1st sentence words to others
Abbreviation feature: copy features of name to mentions of abbr.

The features computation does not calculate features for isolated pinned tokens. The computations combine hashes, combine tries, and combine regular expressions. Features are only computed when necessary (for example punctuation tokens are not in any hashes so do not look them up). Once the model has been trained, the Viterbi algorithm (or an algorithm similar in function) is used to efficiently find the most probable sequence of tags given the input and the trained model. After the algorithm determines the most probable sequence of tags, the text, such as tagged sentence 119, where the entities are located is passed to a resolver, such as entity resolver 120.

Entity resolver 120 provides additional information on an entity by matching an identifier for an external object within authority files 130 to which the entity refers. The resolver in the exemplary embodiment uses rules instead of a statistical model to resolve named entities. In the exemplary embodiment, the external object is a company authority file containing unique identifiers. The exemplary embodiment also resolves person names.

The exemplary resolver uses three types of rules to link names in text to authority file entries: rules for massaging the authority file entries, rules for normalizing the input text, and rules for using prior links to influence future links. Other embodiments include integrating the statistical model and resolver.

This list along with the original text is the input to an entity resolver module. The entity resolver module takes these tagged entities and decides which element in an authority file the tagged entity refers. In the exemplary embodiment, authority file 130 is a database of information about entities. For example an authority file entry for Swatch might have an address for the company, a standard name such as Swatch Ltd., the name of the current CEO, and a stock exchange ticker symbol. Each authority file entry has a unique identity. In the previous example a unique id could be, ID:345428, “Swatch Ltd.”, Nicholas G. Hayek Jr., UHRN.S. The goal of the resolver is to determine which entry in the authority file matches corresponds a name mention in text. For example, it should figure out the Swatch Group refers to entity ID:345428. Of course, resolving names like Swatch is relatively easy in comparison to a name like Acme. However, even for names like Swatch, a number of related but different companies may be possible referents. What follows is a heuristic resolver algorithm used in the exemplary embodiment:

### Heuristic Resolver Algorithm for Companies

Iterate through entities tagged by the CRF:
If entity tagged as ORG:
If a “do not resolve” ORG (i.e., stock exchange abbreviations):
set ID attribute to “NOTRESOLVED”
Else:
If entity in the company authority file,
set ID attribute to company ID
Else:
set ID attribute to “NOTRESOLVED”
Iterate through NOTRESOLVED entities:
If E is a left-anchored substring of a resolved company:
set ID attribute to already resolved company substring match ID,
change the tag kind to ORG, if necessary
If E is an acronym of an already-resolved company:
set ID attribute to already resolved non-acronym company ID,
change the tag kind to ORG, if necessary

Note that the exemplary entity tagger and variations thereof is not only useful for named entity tagging. Many important data mining tasks can be framed as sequence labeling. In addition, there are many problems for which high precision (but low recall) external classifiers are available that may have been trained on a separate training set.

### Exemplary Event and Relationship Extraction System

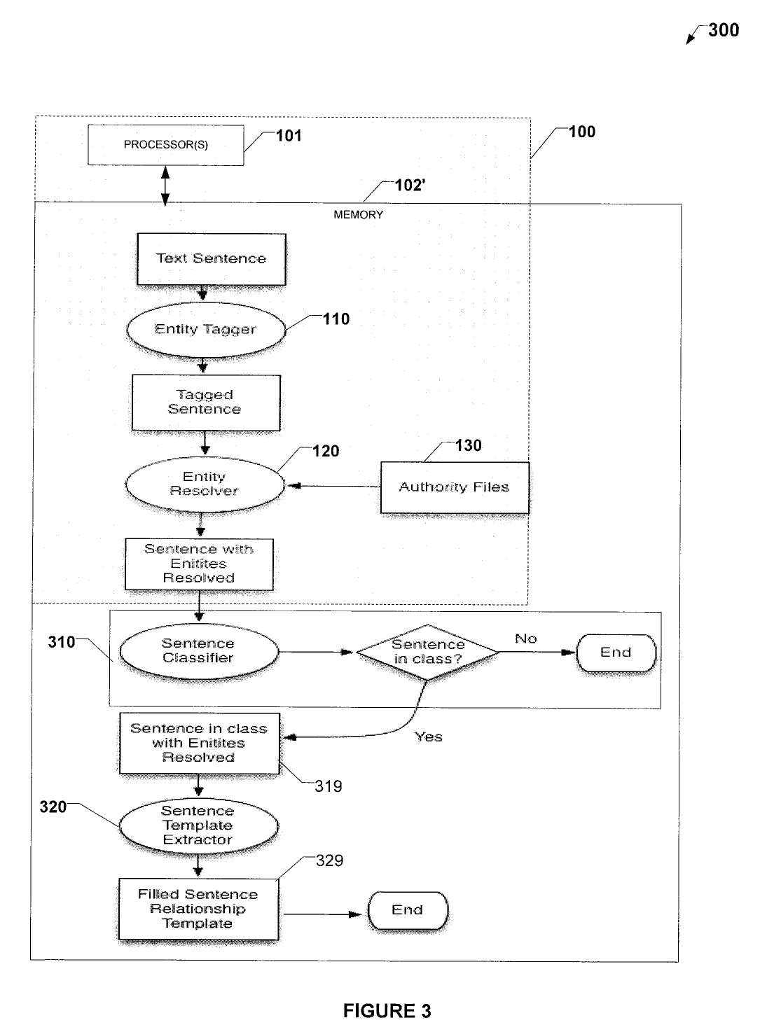

FIG. 3 shows an exemplary system 300 which builds onto the components of system 100 with a classifier 310 and a template extractor 320, which are shown as part of memory 102, and understood to be implemented using machine-readable and machine-executable instructions.

Classifier 310, which accepts tagged and resolved text such as sentence 129 from resolver 120, identifies sentences that contain extractable relationship information pertaining to a specific relationship class. For example, if one is interested in the hiring relationship where the relationship is hire (firm, person), the filter (or classifier) 312 identifies sentence (1.1) as belonging to the class of sentences containing a hiring or job-change event and sentence (1.2) as not belonging to the class.

(1.1) John Williams has joined the firm of Skadden & Arps as an associate.

(1.2) John Williams runs the billing department at Skadden & Arps.

The exemplary embodiment implements classifier 310 as a binary classifier. In the exemplary embodiment, building this binary classifier for relationship extraction entails:
1) Extracting articles from a target database;
2) Splitting sentences in all articles and loading to a single file;
3) Tagging and resolving types of entities relevant to a relationship type that occur within each sentence;
4) Selecting from set of sentences all sentences that have the minimal number of tagged entities needed to form a relationship of interest.
This means for example that at least one person name and one law firm name must be specified in a sentence for it to contain a job change event. Sentences containing requisite number of tagged entity types are called candidate sentences;
5) Identifying 500 positive instances from the candidate set and 500 negative instances. A sentence in the candidate set that actually contains a relationship of interest is called a positive instance. A sentence in the candidate set that does not contain a relationship of interest is called a negative instance. All sentences within the candidate set are either positive or negative instances. These sampled instances should be representative of their respective sets and should be found as efficiently as possible;
6) Creating classifier that combines selected features with selected training methods. Exemplary training methods include naive bayes and Support Vector Machine (SVM.) Exemplary features include co-occurring terms and syntax trees connecting relationship entities; and
7) Testing the classification of randomly selected sentences from candidate pool. After testing the exemplary embodiment evaluates first hundred sentences classified as positive (for example, job change event containing) and first hundred classified as negative, computing precision and recall and saving evaluated sentences as gold data for future testing.

A range of filters that are either document-dependent filters or complex relation detection filters based on machine learning algorithms are developed and tools that easily retarget new document types. The structure of a document type provides very reliable clues on where the sought after information can be found. Ideally, the filter is flexible and automatically detects promising areas in a document. For example, a filter that includes a machine learning tool (for example Weka) that detects promising areas and produces pipelines that can be changed according to the relevant features needed for the task.

Depending on the requirements, different levels of co-reference resolution can be implemented. In some domains, no co-reference resolution is used. Other situations use a relatively simple set of rules for co-reference resolution, based on recent mentions in the text and identifiable attributes (i.e., gender, plurality, etc.) of the interested named entities. For example, in the job change event, almost all co-reference issues are solved by simply referring backward to the most recent mention of the matching entity type (that is, law firm or lawyer name).

Template extractor 320 extracts event templates from positively classified sentences, such as sentence 319, from classifer 310. In the exemplary embodiment, extracting templates from sentences involves identifying the name entities participating in the relationship and linking them together so that their respective roles in the relationship are identified. A parser is utilized to identify noun phrase chunks and to supply a full syntactic parse of the sentence.

In the exemplary embodiment, implementing extractor 320 entails:
1) Create gold data by taking positive example sentences from classification phase and manually generating appropriate template records. The user is automatically presented with all possible templates which could be generated from the sentence and asking the user to select the one that is correct;
2) Take 400 sentences from gold data set for training data and develop extraction programs based on one or more of the following technologies: association rules, chunk kernel based on chunks, CRF, and tree kernel based on syntactic structure;
3) Test solutions on 100 held out test samples;
4) Combine classifier with extractor to test precision using unseen data.
For instance, a sentence containing a job change event is one that describes an attorney joining a law firm or other organization in a professional capacity. The target corpora from which job change events are extracted are legal newspaper databases. The minimal number of tagged entities which qualify a sentence for inclusion in the candidate set is one lawyer name and one legal organization name. One way to efficiently collect positive and negative training instances is to stratify samplings. This can be done by sorting the sentences according to the head word of the verb phrase that connects a person with a law firm in the sentence. Then collect all head verbs that occur at least five times under a single bucket. After collection, select five example sentences from each bucket randomly and mark them as either positive or negative examples. For each bucket that yields only positive examples, add all remaining instances to the positive example pool. And for each bucket that yields only negative examples, add all examples to the negative examples group. If there are less than 500 positive examples or less than 500 negative examples, manually score randomly selected sentences until 500 examples of each time are identified. The job change event extractor moves identified entities from a positively classified job change event sentence into a structured template record. The template record identifies the roles the named entities and tagged phrases play in the event.
   The template below (which also represents a data structure) is in reference to sentence 1.1 above.

| Role | Value | Entity ID |
|---|---|---|
| Attorney | John Williams | A23456 |
| Firm | Skadden & Arps | F56748 |
| Position | Associate | P234 |

In another embodiment, classifer 310 determines whether tagged and resolves sentences (or more generally text segments) from entity resolver 120 include a merger and acquisitions event, that is, an event in which one company merges with or acquires another company. The target corpora for extracting merger and acquisition events are financial news wire articles. The minimal number of tagged entities which qualifies a sentence for inclusion in the candidate set is two company names. To help collect training data, utilize structured records from merger and acquisitions database on Westlaw® information-retrieval system (or other suitable information-retrieval system) to identify merger and acquisition events that have taken place in the recent past. To efficiently identify positive training instances from the candidate set, find sentences that contain the names of entities that match these records and were published during the time frame over which the merging event took place. To identify negative instances, select sentences that contain companies are known to not have been involved in a merger or acquisition. The merger and acquisition (M & A) event extractor moves identified entities from a positively classified M & A change event sentence into a structured template record. The template record identifies the roles the named entities and tagged phrases play in the event.

Another embodiment classifies and extracts net income announcement events in sentences. A net income announcement event occurs when a company announces it has expected or actualized net income over a specific time frame. The target corpora for extract merger and acquisition events are financial news wire articles. The minimal number of tagged entities which qualifies a sentence for inclusion in the candidate set is one company name and the phrase “net income” or the word “profit”. To efficiently find positive instances, extract net income information from SEC documents for particular companies and find positive candidates when the named company in the sentence and the dollar amount or percentage increase in profit for a time period line up with information from an SEC document. Negative instances are found when the data for a particular company does not line up with SEC filings. The net income announcement event extractor moves identified entities from a positively classified net income announcement event sentence into a structured template record. The template record identifies the roles the named entities and tagged phrases play in the event.

An additional embodiment of the present invention includes a tool that generates sentence paraphrases starting from the seed templates provided by a user. The tool takes sentences that indicate an event with high precision with the actual entities replaced by their generic types. The sentence is searched for in a corpus and the actual entity identities are obtained. Then other sentences are located with the same entities in the corpus (perhaps in a narrow time window) which saves as paraphrases for the initial sentence. This step can now be repeated with the newly acquired sentences. The sentences can be ordered according to frequencies of component phrases and manually checked to generate gold data.

Various assumptions are incorporated in the exemplary embodiment. One main assumption is that the identity of the entities is usually independent of the way of talking about an event or relationship. Another assumption is that the extraction of sentences deemed paraphrases based upon the equality of constituent entities and time window is relatively error-free. The precision of this latter filtering step is improved by having other checks such as on the cosine similarity between the documents in which the two sentences are found, similarity of titles of the documents etc. This approach entails the following:
1) Providing a large corpus of documents preferably having the property that several documents talking about the same event or relationship from different authors are easy to find. One example is a time-stamped news corpus from different news sources, where the same event is likely to be covered by different sources;
2) Using a named entity recognizer to tag the entities in the corpus with reasonable accuracy. Clearly the set of entities that need to be covered by the NER (named-entity resolver) depends upon the extraction problem;
3) Providing an indexer for efficient search and retrieval from the corpus;
4) Providing a human generated list of high-precision sentences with the entities replaced by wild-cards. For example, for MA, a human might provide a rule “ORG1 acquired ORG2” means this is an MA sentence with ORG1 being the buyer and ORG2 being the target.

Another embodiment entails extraction of information from tables found in text. An SVM classifier (or another classifier similar in function) distinguishes tables from non-tables. Tables that are only used for formatting reasons are identified as non-tables. In addition, tables are classified as tables of interest, such as background, compensation, etc. The feature set comprises text before and after the tables as well as n-grams of the text in the table. The tables of interest are then processed according to the following:

1) label/value detection. The table has to be partitioned in the labels and the values. For the exemplary table below, the system determines that the money amounts are values and the rest are labels;

2) label grouping. Some labels are grouped together. For example, Eric Schmidt and his current position are one label. On the other hand, a table that contains a year and a list of term names (i.e. Winter, Spring, Fall) are not grouped together;

3) abstract table derivation. A derived Cartesian coordinate system leads to the notation that defines every value accordingly. [Name and Principal Position.Eric Schmidt Chairman of the Executive Committee and Chief Executive Officer.Year.2005, Annual Compensation.Salary($)]=1;

4) relation extraction. Given the abstract table representation, the desired relations are derived. The compensation relation, for example, is filled with: NAME: Eric Schmidt; COMPENSATION TYPE: salary; AMOUNT: 1; CURRENCY: $. Finally, an interpreter for the tables of interest is created. The input to the interpreter is a table and the output is a list of relations represented by the table.

| | | Annual Compensation | | |
|---|---|---|---|---|
| Name and Principal | | | | other Annual |
| Position | Year | Salary($) | Bonus($) | Compensation($) |
| Eric Schmidt | 2005 | 1 | 1,630 | 24,741 |
| Chairman of the | 2004 | 81,432 | 1,556 | 0 |
| Executive Commit- | | | | |
| tee and Chief | | | | |
| Executive Officer | | | | |

### Exemplary Methods of Operating a Named-Entity Tagging, Resolution and Event and Relationship Extraction System

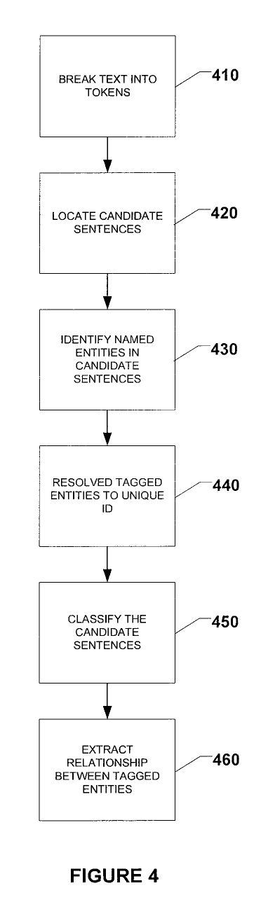

FIG. 4 shows a flow chart 400 of an exemplary method of operating a named entity tagging, resolution, and event extraction system, such as system 300 in FIG. 3. Flow chart 300 includes blocks 410-460, which are arranged and described serially. However, other embodiments also provide different functional partitions or blocks to achieve analogous results.

Block 410 entails breaking the extracted text into tokens. Execution proceeds at block 220.

Block 420 entails locating parts of the extracted text that need to be processed. In the exemplary embodiment, this entails use of zoner 112 to locate candidate sentences for processing. Execution then advances to block 230.

Block 430 entails finding the named entities within the processed parts of extracted text. Then the entities of interest in the candidate sentences are tagged. Candidate sentences are sentences from target corpus that might contain a relationship of interest. For example, one embodiment identifies text segments that indicate job-change events; another identifies segments that indicate merger and acquisition activity; a yet another identifies segments that may indicate corporate income announcements. Execution continues at block 440.

Block 440 entails resolving the named entities. Each entity is attached to a unique ID that maps the entity to a unique real world object, such as an entry in an authority file. Execution then advances to block 250.

Block 250 classifies the candidate sentences. The candidate sentences are classified into two sets: those that contain the relationship of interest and those that do not. For example, one embodiment identifies text segments that indicate job-change events; another identifies segments that indicate merger and acquisition activity; a yet another identifies segments that may indicate corporate income announcements. When the text is classified, executes advances to block 260.

Block 260 entails extracting the relationship of interest using a template. More specifically, this entails extracting entities from text containing the relationship and place the entities in a relationship template that properly defines the relationship between the entities. When the template is completed, the extracted data may be stored in a database but it may also involve more complex operations such as representing the data according a time line or mapping it to an index.

Some embodiments of the present invention are implemented using a number of pipelines that add annotations to text documents, each component receiving the output of one or more prior components. These implementations use the Unstructured Information Management Architecture (UIMA) framework and ingest plain text and decomposes the text into components. Each component implements interfaces defined by the framework and provide self-describing metadata via XML descriptor files. The framework manages these components and the data flow between them. Components are written in Java or C++; the data that flows between components is designed for efficient mapping between these languages. UIMA additionally provides a subsystem that manages the exchange between different modules in the processing pipeline. The Common Analysis System (CAS) holds the representation of the structured information Text Analysis Engines (TAEs) add to the unstructured data. The TAEs receive results from other UIMA components and produce new results that are added to the CAS. At the end of the processing pipeline, all results stored in the CAS can be extracted from there by the invoking application (for example, database population) via a CAS consumer. Primitive TAEs (for example, tokenizer, sentence splitter) can be bundled into an aggregate TAE. Other embodiments use alternatives to the UIMA.framework.

### Appendix

### Exemplary Extraction of Information from Tables Found in Text

For the exemplary embodiment, we downloaded hundreds of documents from Edgar database (EDGAR) and annotated 150 of them for training and evaluation. We converted the documents into XHTML using Tidy (Raggett) before annotating them.

TABLE 3
A compensation table

| | | Annual Compensation | | | Long-Term | |
|---|---|---|---|---|---|---|
| | | | | Other Annual | Compensation | All Other |
| | Fiscal | Salary | Bonus | Compensation | Awards | Compensation |
| Name and Principal Position | Year | (S) | (S)(l) | (S) | Options (#) | (S)(2) |
| John T. Chambers | 2005 | 350,000 | 1,300,000 | 0 | 1,500,000 | 8,977 |
| President, Chief Executive | 2004 | 1 | 1,900,000 | 0 | 0 | 0 |
| Officer and Director | 2003 | 1 | 0 | 0 | 4,000,000 | 0 |
| Mario Mazzola | 2005 | 447,120 | 557,737 | 0 | 600,000 | 7,424 |
| Former Senior Vice President, | 2004 | 464,317 | 666,850 | 0 | 600,000 | 5,726 |
| Chief Development Officer (3) | 2003 | 447,120 | 764,897 | 0 | 500,000 | 2,905 |
| Charles H. Giancarlo | | | | | | |
| . . . | | | | | | |

Our information extraction system for genuine tables involve the following:
1. table classification
2. label row and column classification
3. table structure recognition
4. table understanding

Step 1, which is implemented to maintain efficiency, entails identifying tables that have a reasonable chance of containing the desired relation before deep analysis are applied. The tables containing the desired information are quickly identified using relation-specific classifiers based on supervised machine learning. In Step 2, we distinguish between label column and label rows from values inside those tables. This time, the same supervised machine learning approach is used, but the training data is different from those in Step 1. In Step 3, after those label rows and label column are identified, an elaborate procedure is applied to these complex tables to ensure that semantically coherent labels are not separated into multiple cells, or multiple distinct labels are not squashed into a cell. The goal here is to associate each value with their labels in the same column and the same row. The result of the Step 3 is a list of attribute-value pairs. In Step 4, a rule-based inference module goes through each attribute-value pairs and identify the desirable ones to populate the officers and directors database.

Before providing the details of those steps, we will first describe the annotation for performing the supervised learning employed in both Step 1 and Step 2.

Annotation Requirements: In the early stage of the project, we originally categorized tables containing desired information based on the overall information conveyed in each table, such as “officer compensation” or “director committee assignment”. We annotate tables with the desired relations directly. In SEC filings, the relation “name+title” might appear in various categories of tables, which makes the original table categories ineffective. In addition, there are too many variations of tables in this domain which makes defining an effective closed set of categories difficult. For example, Table 3 is a compensation table, but it also contains job title information.

To make our system more robust against lexical variations and table variations, we employed supervised machine learning in Step 1 and Step 2. As we know in supervised learning, one of the most challenging and time-consuming tasks is to obtain the labeled examples. To make our approach reusable across different domains, we developed a scheme that minimizes the human annotation effort needed.

For the tables containing the desired information, the exemplary embodiment uses the following annotations:
1. isGenuine: a flag indicates that this is a genuine table or a non-genuine table.
2. relations: the relations that a table contain, such as “name+title”, “name+age”, name+year+salary” or “name+year+bonus”, or a combination of them.
3. isContinuous: a flag indicates that if this table is a continuation of the previous genuine table.
4. lastLabelRow: the row number of the last label row.
5. lastLabelColumn: the column number of the last label column associated with each relation.
6. valueColumn: the number of the column that contains the desired values for each relation.

The specified relations are used as training instances to build models for Step 1. The information lastLabelRow and lastLabelColumn are used to build models to classify rows and column as labels rows or columns in Step 2. In our guideline to annotators, we specifically ask them to annotate the column number of the last label column for each relation. The need for such fine-grained annotation is best illustrated using an example. In Table 3, for relation “name+title”, the last label column is 1, the column “name and principal position”. But for relation “name+year+bonus”, the last label column is 3, “fiscal year”. For extracting multiple relations in a table, these relations might share the same last label column, but this is not always the case. As a result, there is a need to annotate the associated label column for each relation separately. The flag is Continuous indicates if the current table is a continuation of the previous table. If it is, the current table can “borrow” the boxhead from previous table since such information is missing. We eliminate tables marked with “isContinuous” flag during training, but kept those table during evaluation. The annotation valueColumn can be used for automatic evaluation in the future.

There are few rare instances where the default arrangement of boxhead and stub, as shown in Table 3, are swapped in the corpus. Currently in our annotation, we simply don't supply “valueColumn” for the relations since they don't apply. For table classification and table understanding tasks, this is not of much an issue, but the above annotation scheme would need to be further modified to capture such difference.

Table classification: Much of past work in table classification focused on distinguishing between genuine and non-genuine tables (Wang & Hu 2002). For information extraction, we need to go a step further. We also need to know if a table contains the desired information before we perform expensive operations on it. To identify tables that contain desired relations, we employed LIBSVM (Chang & Lin 2001), a well-known implementation of support vector machine. Based on the annotated tables, a separate model is trained for each desired relation. In SEC domain, a table might contain multiple relations.

Exemplary features include:
top 1000 words inside tables in the corpus, and top 200 words in text preceding the tables. These thresholds are based on experiments using LIBSVM 5-fold cross validation. A stop word list was used.
number of words in tables that are label words
number of cells containing single word
number of cells containing numbers
maximum cell string size
number of names
number of label words in the first row

We built a model for each desired relations. Because “name+year+salary” and “name+year+bonus” cooccur 100% of the time in the annotated corpus, the same classifier was for both relations. In this domain, the number of negative instances is significantly larger than positive instances (3building an accurate model. We suspected that having both signature tables and tables containing background information in sentences format create significant overlap between positive and negative instances. To address this, we only use a subset of negative instances for training (75% of our training instance are negative instances). We also trained a separate module for distinguish between a genuine and non-genuine tables based on annotated data. This second model is relation independent. The feature set is similar to the feature set mentioned above.

To identify which words are likely to be names, we downloaded the list of names from (U.S. Census Bureau). The list of names is further filtered by removing the common words, such as “white”, “cook”, or “president”, based on a English word list (Atkinson August 2004). At our disposal, we also have a list of common title words. We intentionally do not use such information in this paper to make our result more generalizable to other domains. We can imagine using such information would significantly improve the precision and recall for extracting relation “name+title”.

Label row and column classification: Based on the annotated data, LIBSVM is again used to classify which rows belong to boxhead and which columns belong to stub. The training data for the models are words in the desired tables that were manually identified as box-head and stubs by using lastLabelRow and lastLabelColumn features. Other features used include the frequency of label words, the frequency of name words, and frequency of numbers.

For each relation, the exemplary embodiment uses a different label column classifier, since the lastColumnLabel might differ between different relations, as explained in the Annotation Section.

Table structure recognition: Because tables in the SEC filings are somewhat complex and formatted for visual purpose, a significant amount of effort is needed to normalize the table to facilitate later operations. Once label rows and columns are identified, several normalization operations are carried out:
1. create duplicate cells based on rowspan and columnspan
2. merge cells into coherent label cells
3. identify subheadings
4. split specific column based on conjoin marker, such as “and” or parenthesis (before last label column)
5. split cells containing multiple labels, such as years “2005, 2006, 2007”

Step 1 specifically addresses the issue with the use of columnspan and rowspan in HTML table, as have been done in (Chen, Tsai, & Tsai 2000). In Table 3, without copying the original labels into spanning cells, the label “annual compensation” would not be attached to the value “1,300,000” using just the HTML specification. By doing this step, we only need to associate all the labels in the box-head in that particular column to the value and ignore other columns.

In Step 2, we use certain layout information, such as underline, empty line, or background color, to determine when a label is really complete. In SEC filings, there are many instances where a label is broken up into multiple cells in the boxhead or stub. In those cases, we want to recreate the semantically meaningful labels to facilitate later relation extraction—a process that is heavily dependent on the quality of the labels attached to the values. For example, in Table 3, based on the separate in row 5, cells “John T. Chambers”, “President, Chief Executive”, and “Officer and Director” are merged into one cell, with line break marker (#) inserted into the original position. The new cell is “John T. Chambers#President, Chief Executive#Officer and Director”, and it is stored in cell on row 2, and copied to cells on row 3 and 4.

In Step 4, heuristic rules were applied to identify subheader. For example, if there is no value in the whole row except for the first label cell, then that label cell is classified as subheader. The subheader label is assigned as part of the label to every cell below it until a new subheader label cell is encountered.

Step 5 splits certain columns into multiple columns to ensure that a value cell does not contain multiple values. For example, in Table 3, the first cell in first column is “name and principal position”. The system detects the word “and” and split the column into two columns, “name” and “principal position”, and do similar operations to all the cells in the original column. Remember in Step 3, cell on row 2 is the result of merge 3 cells, with line break markers between the string in the original cells. By default, we use the first line break marker to break the merged cell into two cells. After this transformation, we have “John T. Chambers” and “President, Chief . . . ” that corresponding to “name” and “principal position”. This type of operation is not only limited to “and”, but also to certain parenthesis, “Nondirector Executive Officer (Age as of Feb. 28, 2006)”. Such cells are broken into two, and so are the other cells in the same column.

Step 6 deals with repeated sequences in last label column. In Table 3, we are fortunate that all the cells under “fiscal year” contains only 1 value. There are instances in our corpus that such information is represented inside the same cell with line break between each value. In such cases, there are no lines between these values, and the resulting table looks cleaner and thus visually more pleasing. It is certainly incorrect to assign all 3 years “2005, 2004, 2003” to the cell containing bonus information “1,300,000”. To address this, our system performs repeated sequence detection on all last label columns. If a sequence pattern, which doesn't always have to be exactly the same, is detected, the repeated sequence are broken into multiple cells so that each cell can be assigned to the associated value correctly.

Transforming a normalized table to Wang's representation (Wang 1996) is a trivial process. Given a value cell at (r,c), all the label cells in column (c) and row (r) are its associated labels. In addition, the labels in stub might also have additional associated labels in the boxhead, and those should be associated with the value cell also. For example, the value “1,300,000” will have following 4 associated labels: [annual compensation|bonus($)(1)], [fiscal year|2005], [principal position|president, chief executive officer and director], [name|John T. Chambers]. The characters “|” inside those associate labels indicate hierarchical relation between the labels. For tables with subheading, the subheading labels have already been inserted into all the associated labels in the stubs earlier.

Table understanding: Similar to (Gatterbauer et al. 2007), we consider IE from Wang's model requires further intelligent processing. To populate database based on Wang's representation, a rule-based system is used. We specifically look for certain patterns, such as “name”, “title” or “position” in the associated labels in order to populate the “name-title” relation. For different relations, a different set of patterns is used. It's important to perform error analysis at this stage to detect ineffective patterns. For example, several tables with “name-title” information used the phrase “nondirector executive officer” instead of the label for “name”. Clearly, we can apply supervised machine learning to make the process more robust. In our annotation, we have asked the annotators to identify the columns that contains the information we want in valueColumn. Such information might be used to train our table understanding module in the future.

The following procedures can be used to tailor our approach to a new application or domain:
Collect a corpus and annotate the tables with the desired information as described in the Annotation section.
Modify features to take advantage of knowledge in the new domain.
Train all the classifiers. Depending on the size of the corpus, different thresholds can be specified to minimize the size of the vocabulary, which is used as features. This training process can be automated.
Modify table normalization to take advantage of domain knowledge. For example, in SEC domain, separating the label cell “name and title” is applied in order to simply later relation extraction operations.
Modify relation extraction rules. Different relations are signaled by different words in the labels. Currently, we manually specify these rules.
   This process is designed to maximize precision and recall while minimizing the annotation effort. Each component can be modified to take advantage of the domain specific information to improve its performance.

### CONCLUSION

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the issued claims and their equivalents.

What is claimed is:

1. A computer system having at least one processor and at least one memory, the system comprising:
means for automatically tagging entity names within a text segment as being one of a person, company, and location; and
means for logically associating one or more of the tagged entity names with an entry in a data set of named entities.

2. The system of claim 1, wherein the means for tagging entity names within a text segment, includes:
means for automatically pretagging one or more portions of the text segment as being one of a person, company, and location based on a list or rule; and
a statistical sequence decoder, responsive to the means for pretagging, for tagging other portions of the text segment as being one of a person, company, or location.

3. The system of claim 2, wherein the means for pretagging includes a list of company names.

4. The system of claim 2, wherein the means for pretagging includes a set of one or more text pattern rules.

5. The system of claim 2, wherein the statistical sequence decoder includes a Viterbi decoder.

6. The system of claim 1, wherein the means for tagging entity names outputs a character positions for each tagged named entity.

7. The system of claim 1, further comprising:
means for automatically classifying a tagged text segment as having a minimal number of tagged entities to form a relationship of interest having at least first and second roles; and
means, responsive to the classifying means, for automatically determining which of the tagged entities in the tagged text segment that is classified as having a minimal number of tagged entities has the first role and which has the second role.

8. A computer implemented method comprising:
automatically tagging entity names within a text segment as being one of a person, company, and location; and
automatically associating one or more of the tagged entity names with an entry in a data set of named entities.

9. The method of claim 8, wherein automatically tagging entity named within the text segment, includes:
pretagging one or more portions of the text segment as being one of a person, company, and location based on a list or rule; and
using a statistical sequence decoder to tag other portions of the text segment as being one of a person, company, or location.

10. The method of claim 9, wherein the statistical sequence decoder includes a Viterbi decoder.

11. The method of claim 8, further comprising:
automatically classifying a tagged text segment as having a minimal number of tagged entities to form a relationship of interest having at least first and second roles; and
automatically determining which of the tagged entities in the tagged text segment that is classified as having a minimal number of tagged entities has the first role and which has the second role.

12. A computer-implemented method comprising:
automatically tagging one or more portions of a text segment as being one of a person, company, and location based on a list or rule; and
using a statistical sequence decoder to tag other portions of the text segment as being one of a person, company, or location.

13. The method of claim 12, wherein the statistical sequence decoder includes a Viterbi decoder.
